(19) United States
(12) Patent Application Publication
(10) Pub. No.: US 2019/0345734 A1
(43) Pub. Date: Nov. 14, 2019

(54) DOOR HANDLE FOR PROVIDING A BUFFERING EFFECT

(71) Applicant: EVER SILVER INDUSTRIAL CO., LTD., Changhua County (TW)

(72) Inventor: Hung-Ming WU, Changhua County (TW)

(21) Appl. No.: 15/975,648

(22) Filed: May 9, 2018

(51) Int. Cl. E05B 17/00; E05B 3/06

(52) U.S. Cl. CPC E05B 17/0045; E05B 3/065; E05B 17/0041

(57) ABSTRACT

A door handle for providing a buffering effect has a base, a rotator, an elastic component, a linker, a handle lever, and a damper. The rotator is engaged through the base. The elastic component hooks a limiting rod of the base and the rotator. The linker is disposed around the rotator and has a restricting rib and a pivot rod. The handle lever is inserted into the rotator. A mini buffer of the damper has a cylinder body mounted to the base, and a piston rod. A pivot arm of the damper is disposed around a shaft of the base and rotatably mounted to the piston rod. An extending arm is rotatably mounted to the pivot arm and the pivot rod, respectively. Since damping impact of the buffer effectively retards the restoring process, the strike of the backwardly swinging handle lever is buffered.

### BACKGROUND OF THE INVENTION

### 1. Field of the Invention

The present invention relates to a door handle, and more particularly to a door handle for providing a buffering effect.

### 2. Description of Related Art

Generally, a conventional door handle comprises a pair of handle levers and a pair of bases. The two bases are oppositely installed on the two sides of a door plank, and the two handle levers are rotatably inserted into the two bases, respectively. Moreover, a latch tongue that is retractably mounted on the door plank connects to the two handle levers via a connector. When a user turns the handle levers, the latch tongue will be retracted, so the user can open the door.

With reference to FIG. 6, each one of the pair of conventional door handles comprises a base 90, a handle lever 91, a linker 92, and an elastic component 93. The linker 92 is connected to the handle lever 91, and is rotatable relative to the base 90 by the handle lever 91. In addition, the linker 92 is connected to the latch tongue. The elastic component 93 is disposed between and connected to the base 90 and the linker 92, so the elastic component 93 is able to offer a restoring torque to drive the linker 92 and the handle lever 91 to revolve backwardly after the user releases the handle lever 91.

However, the conventional door handles have the following shortcomings.

1. Due to the strong restoring torque provided by the elastic component 93, at the moment the user releases the handle lever 91, the elastic component 93 instantly drives the linker 92 and further makes the handle lever 91 swing back rapidly. As a result, the user's hand could be easily hit and hurt by the handle lever 91.

2. The rapid restoring process also causes the conventional door handle to produce loud noises.

### SUMMARY OF THE INVENTION

The main objective of the present invention is to provide a door handle for providing a buffering effect which is able to retard the restoring swing-back process of a handle lever, in order to solve the problems of hurting the user and the loud noises produced during the process.

The door handle for providing a buffering effect comprises a base, a rotator, an elastic component, a linker, a handle lever, and a damper. The base has an installation hole, two sockets, a limiting rod, and a shaft. The installation hole is disposed through the base and is connected to an outer side and an inner side of the base. The two sockets are disposed on the inner side of the base and on two sides of the installation hole. The limiting rod protrudes on the inner side of the base and is located below the two sockets. The shaft protrudes on the inner side of the base and is located beside one of the two sockets. The rotator is rotatably engaged with the installation hole of the base and has a noncircular handle hole disposed through the center of the rotator. The elastic component has its two ends respectively hooking the limiting rod of the base and the rotator. The linker is disposed around the rotator and has a restricting rib and a pivot rod. The restricting rib extends from the linker into an area between the limiting rod and the socket that is other than the socket beside the shaft. The pivot rod protrudes on the linker and is spaced apart from the restricting rib. The handle lever has a noncircular end for insertion into the handle hole of the rotator. The damper has a mini buffer, a pivot arm, and an extending arm. The mini buffer comprises a cylinder body mounted to the base, and a piston rod that retractably extends from the cylinder body. The pivot arm is disposed around the shaft by a middle portion and has one of two ends rotatably mounted to the piston rod of the mini buffer. The extending arm has two ends rotatably mounted to the other one of the two ends of the pivot arm and the pivot rod of the linker, respectively.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a pair of door handles for providing a buffering effect in accordance with the present invention;

FIG. 2 is a partially exploded perspective view of one of the door handles in FIG. 1;

FIG. 3 is a side view in partial section of the door handle in FIG. 2;

FIG. 4 is an operational side view in partial section of the door handle in FIG. 2;

FIG. 5 is a perspective view of the door handles in FIG. 1, installed in a door; and

FIG. 6 is a side view in partial section of a door handle in accordance with the prior art.

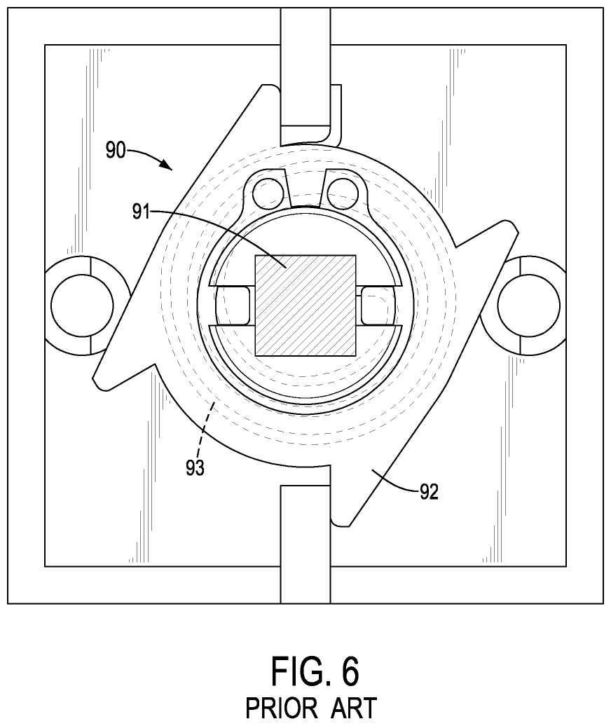

### DETAILED DESCRIPTION OF THE PREFERRED EMBODIMENT

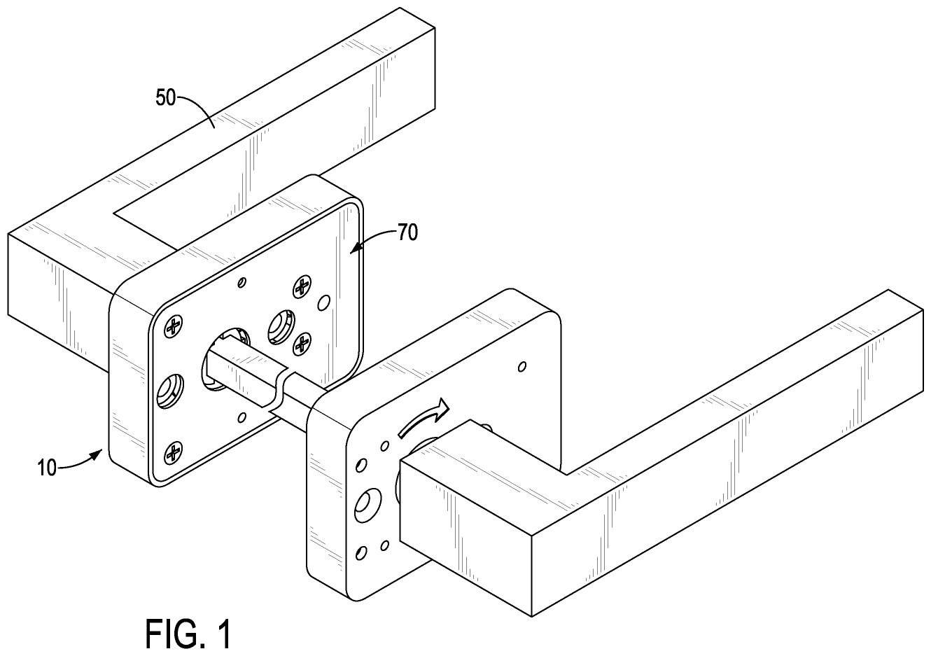

With reference to FIGS. 1 to 3, a door handle for providing a buffering effect in accordance with the present invention comprises a base 10, a rotator 20, an elastic component 30, a linker 40, a handle lever 50, a damper 60, and a cover 70.

The base 10 is a rectangular cap, and has an inner side, an outer side, an installation hole 11, two sockets 12, a limiting rod 13, a shaft 14, and a fixing rod 15. The installation hole 11 is formed through the base 10 to communicate with the inner side and the outer side of the base 10. The two sockets 12 are disposed on the inner side of the base 10, and are disposed on two opposite sides along a radial direction of the installation hole 11. In addition, the two sockets 12 are tubular in shape. The limiting rod 13 is disposed below the two sockets 12. The shaft 14 protrudes beside one of the two sockets 12, away from the installation hole 11. The fixing rod 15 protrudes adjacent to the limiting rod 13.

The rotator 20 is rotatably mounted to the installation hole 11 of the base 10, and has a rotation center, an inner end, a surface, a handle hole 21 and a slot 22. The handle hole 21 is formed through the rotation center of the rotator 20, and has a noncircular shape. In the present embodiment, the handle hole 21 is rectangular. The slot 22 is recessed from the inner end of the rotator 20, and the slot 22 communicates with the handle hole 21. Moreover, the rotator 20 has a C-clip 23 engaged with the surface of the rotator 20 near the inner end of the rotator 20.

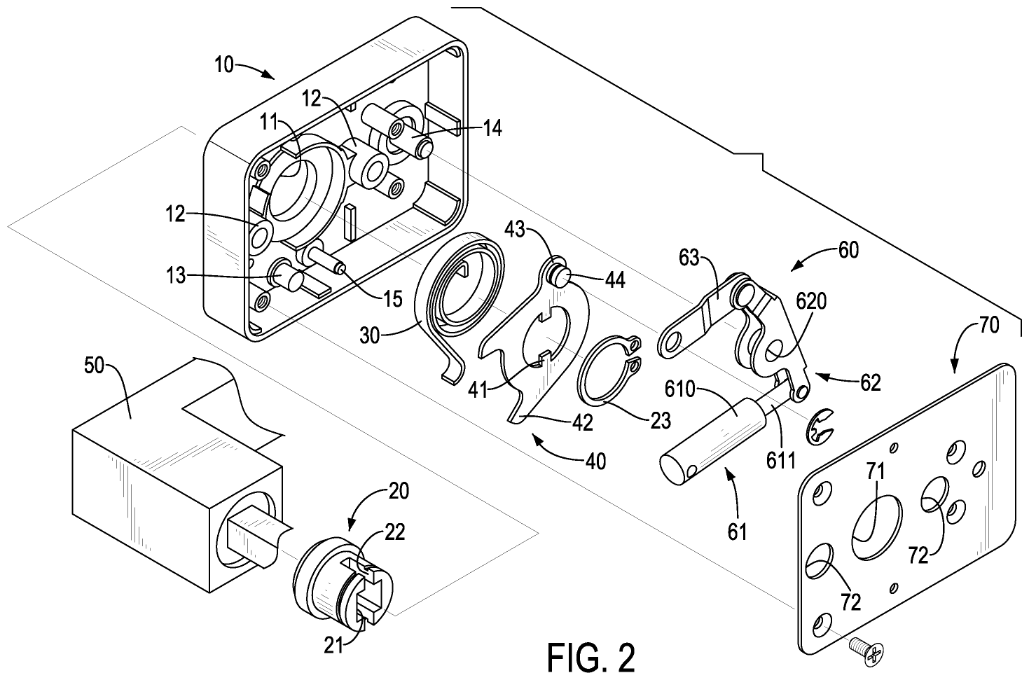

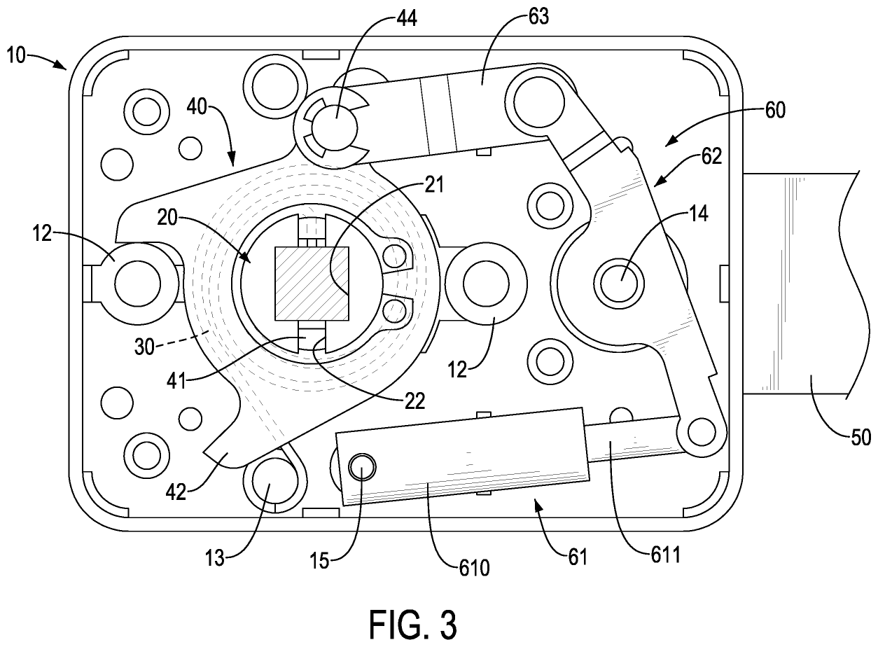

With reference to FIGS. 2 and 3, the elastic component 30 is connected to the base 10 and the rotator 20, with one of two ends of the elastic component 30 hooking the limiting rod 13, and the other one of the two ends hooking the slot 22. In the present embodiment, the elastic component 30 is a torsion spring.

The linker 40 is engaged with the rotator 20, and makes the elastic component 30 located between the base 10 and the linker 40. The linker 40 comprises an inner circumference, an outer circumference, two connecting ribs 41, a restricting rib 42, a pivot rib 43, and a pivot rod 44. The two connecting ribs 41 respectively protrude inwardly from two diametrically opposite points on the inner circumference of the linker 40, and the two connecting ribs 41 are engaged into two ends of the slot 22. The restricting rib 42 is disposed on the outer circumference of the linker 40, and the restricting rib 42 extends into an area between the limiting rod 13 and one of the two sockets 12. The pivot rib 43 is disposed on an opposite side of the linker 40, relative to the restricting rib 42. The pivot rod 44 is protruded on the pivot rib 43 away from the base 10. In addition, the C-clip 23, which is engaged with the rotator 20, enables the linker 40 and the elastic component 30 to firmly mount to the rotator 20, and prevents the linker 40 from falling off the rotator 20.

With reference to FIGS. 1 to 3, the handle lever 50 is L-shaped and has a noncircular cross section. In the present embodiment, the cross section is rectangular, which corresponds to the handle hole 21. The handle lever 50 comprises two ends. One of the two ends of the handle lever 50 is inserted into the handle hole 21 of the rotator 20, and a user can grab on the other one of the two ends of the handle lever 50 so as to turn the handle lever 50.

The damper 60 is movably mounted to the base 10 and is connected to the linker 40. The damper 60 comprises a mini buffer 61, a pivot arm 62, and an extending arm 63. The mini buffer 61 comprises a cylinder body 610 and a piston rod 611. The cylinder body 610 is disposed around the fixing rod 15 of the base 10, and the piston rod 611 retractably extends from the cylinder body 610. Additionally, the mini buffer 61 can be either a hydraulic cylinder or a pneumatic cylinder. The pivot arm 62 has a shaft hole 620 formed through a middle portion of the pivot arm 62, and the pivot arm 62 is rotatably mounted to the shaft 14 via the shaft hole 620. One of two ends of the pivot arm 62 is rotatably mounted to the piston rod 611. The extending arm 63 is connected with the pivot arm 62 and the pivot rod 44, by two ends of the extending arm 63 rotatably mounted to the pivot rod 44 and the other end of the pivot arm 62, which is away from the mini buffer 61, respectively.

The cover 70 covers the inner side of the base 10, to make the rotator 20, the elastic component 30, the linker 40, and the damper 60 received and mounted inside the base 10. The cover 70 has a through hole 71 and two assembly holes 72. The through hole 71 is formed through the cover 70 and aligns with the installation hole 11. The two assembly holes 72 are formed through the cover 70, and are respectively aligned with the two sockets 12.

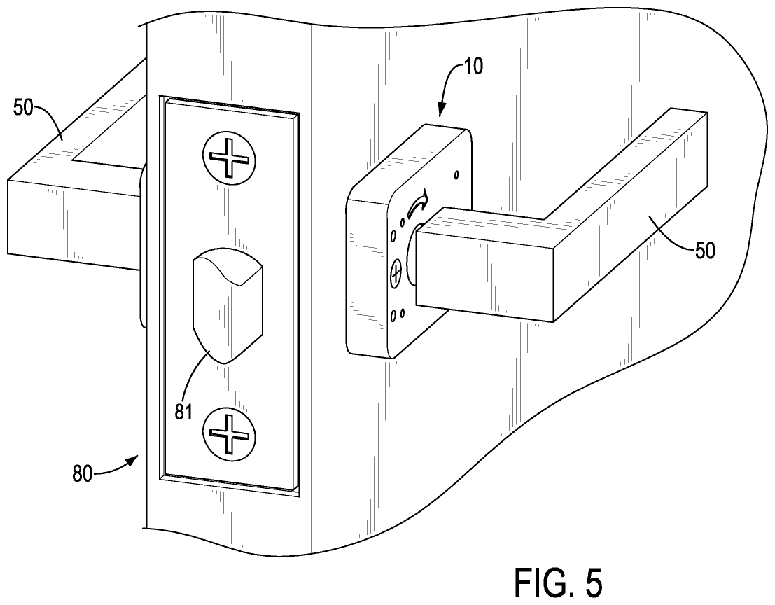

To assemble the door handle for providing a buffering effect, with reference to FIGS. 3 to 5, the first step is to prepare a pair of the door handles mentioned above. Secondly, install the two door handles on a door plank 80, and fasten the two bases 10 with pins (not shown in the figures) through the sockets 12 and the door plank 80. With reference to FIG. 5, a front side of the door plank 80 engages a latch tongue 81. Via a connector, the latch tongue 81 is connected to the two rotators 20 of both of the door handles.

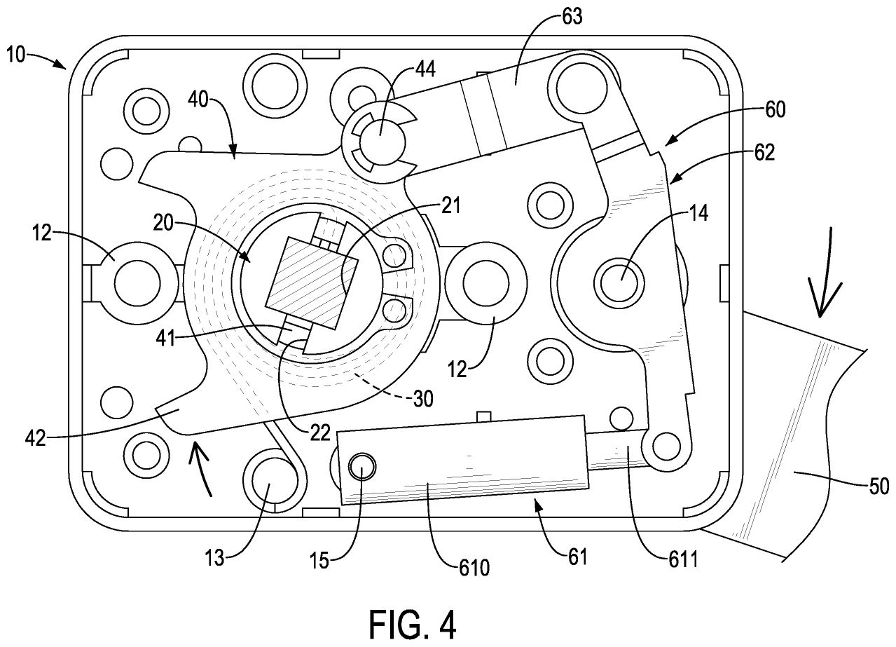

With reference to FIGS. 3 and 4, when the user turns the handle lever 50 of one of the door handles to drive the rotator 20 thereof, the rotator 20 will compress the elastic component 30 and rotate the linker 40 in a clockwise direction. As a result, the restricting rib 42 revolves from the limiting rod 13 toward the corresponding socket 12, and further drives the connector to retract the latch tongue 81. So the user can open the door.

Furthermore, when the linker 40 is rotated in the clockwise direction, the extending arm 63 mounted to the pivot rod 44 is pushed rightward (with reference to FIG. 4). Thus the pivot arm 62 is simultaneously rotated in the clockwise direction, making the piston rod 611 pushed and retracted into the cylinder body 610.

As the user releases the handle lever 50, as shown in FIG. 3, a restoring torque provided by the elastic component 30 drives the rotator 20 to rotate backwardly. The linker 40 is therefore pulled, making the restricting rib 42 revolve backwardly and contact on the limiting rod 13. Due to rotation of the linker 40, the pivot rod 44 pulls the extending arm 63 to move leftward (with reference to FIG. 3). Consequently, the pivot arm 62 revolves in a counterclockwise direction, and pulls the piston rod 611 out of the cylinder body 610, to an extended position.

At this moment, because the displacement of the piston rod 611 relative to the cylinder body 610 tends to be obstructed by the pneumatic pressure or the hydraulic pressure of the mini buffer 61, the rotation of the pivot arm 62 is effectively slowed down. As the extending arm 63, the linker 40, and the rotator 20 are further retarded, the angular velocity and the torque of the backward swing of the handle lever 50 are able to be damped, so as to buffer and reduce noises during the restoring process.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A door handle for providing a buffering effect, the door handle comprising:
a base having
an installation hole disposed through the base and connecting an outer side and an inner side of the base;
two sockets disposed on the inner side of the base and on two sides of the installation hole;
a limiting rod protruding on the inner side of the base and located below the two sockets; and
a shaft protruding on the inner side of the base and located beside one of the two sockets;
a rotator rotatably engaged with the installation hole of the base and having a handle hole disposed through a center of the rotator, and the handle hole being noncircular;
an elastic component with two ends respectively hooking the limiting rod of the base and the rotator;
a linker disposed around the rotator and having
a restricting rib extending from the linker into an area between the limiting rod and the socket that is other than the socket beside the shaft; and
a pivot rod protruding on the linker and spaced apart from the restricting rib;
a handle lever having a noncircular end for insertion into the handle hole of the rotator; and
a damper having
a mini buffer comprising
a cylinder body mounted to the base; and
a piston rod retractably extending from the cylinder body;
a pivot arm disposed around the shaft by a middle portion of the pivot arm and having one of two ends rotatably mounted to the piston rod of the mini buffer; and
an extending arm having two ends rotatably mounted to the other one of the two ends of the pivot arm and the pivot rod of the linker, respectively.

2. The door handle for providing a buffering effect as claimed in claim 1, wherein the rotator has a slot; and the linker has two connecting ribs that protrude inwardly from an inner circumference of the linker, and the two connecting ribs are respectively engaged into two ends of the slot.

3. The door handle for providing a buffering effect as claimed in claim 2, wherein the end of the elastic component that hooks the rotator hooks the slot of the rotator.

4. The door handle for providing a buffering effect as claimed in claim 3, wherein the pivot arm has a shaft hole formed through the middle portion, and the pivot arm is rotatably mounted to the shaft of the base through the shaft hole.

5. The door handle for providing a buffering effect as claimed in claim 4, wherein the linker has a pivot rib radially protruding from an outer circumference of the linker, and the pivot rod axially protrudes from the pivot rib.

6. The door handle for providing a buffering effect as claimed in claim 5, wherein the base has a fixing rod protruding on the inner side, and the cylinder body of the mini buffer is mounted on the fixing rod.

7. The door handle for providing a buffering effect as claimed in claim 6, wherein the elastic component is a torsion spring.

8. The door handle for providing a buffering effect as claimed in claim 1, wherein the handle hole is a rectangular hole, and the handle lever has a rectangular cross section that corresponds to the handle hole.

9. The door handle for providing a buffering effect as claimed in claim 2, wherein the handle hole is a rectangular hole, and the handle lever has a rectangular cross section that corresponds to the handle hole.

10. The door handle for providing a buffering effect as claimed in claim 3, wherein the handle hole is a rectangular hole, and the handle lever has a rectangular cross section that corresponds to the handle hole.

11. The door handle for providing a buffering effect as claimed in claim 4, wherein the handle hole is a rectangular hole, and the handle lever has a rectangular cross section that corresponds to the handle hole.

12. The door handle for providing a buffering effect as claimed in claim 5, wherein the handle hole is a rectangular hole, and the handle lever has a rectangular cross section that corresponds to the handle hole.

13. The door handle for providing a buffering effect as claimed in claim 6, wherein the handle hole is a rectangular hole, and the handle lever has a rectangular cross section that corresponds to the handle hole.

14. The door handle for providing a buffering effect as claimed in claim 7, wherein the handle hole is a rectangular hole, and the handle lever has a rectangular cross section that corresponds to the handle hole.

15. The door handle for providing a buffering effect as claimed in claim 1, wherein a C-clip is further engaged with the rotator on where the linker is disposed.

16. The door handle for providing a buffering effect as claimed in claim 7, wherein a C-clip is further engaged with the rotator on where the linker is disposed.

17. The door handle for providing a buffering effect as claimed in claim 14, wherein a C-clip is further engaged with the rotator on where the linker is disposed.

18. The door handle for providing a buffering effect as claimed in claim 1, wherein a cover covers the inner side of the base and makes the rotator, the elastic component, the linker, and the mini buffer received and mounted inside the base, and the cover further has
a through hole formed through the cover at a location that aligns with the installation hole; and
two assembly holes formed through the cover, and respectively aligning with the two sockets.

19. The door handle for providing a buffering effect as claimed in claim 7, wherein a cover covers the inner side of the base and makes the rotator, the elastic component, the linker, and the mini buffer received and mounted inside the base, and the cover further has
a through hole formed through the cover at a location that aligns with the installation hole; and
two assembly holes formed through the cover, and respectively aligning with the two sockets.

20. The door handle for providing a buffering effect as claimed in claim 17, wherein a cover covers the inner side of the base and makes the rotator, the elastic component, the linker, and the mini buffer received and mounted inside the base, and the cover further has
a through hole formed through the cover at a location that aligns with the installation hole; and
two assembly holes formed through the cover, and respectively aligning with the two sockets.
